(19) United States
(12) Patent Application Publication
(10) Pub. No.: US 2012/0290719 A1
(43) Pub. Date: Nov. 15, 2012

(54) METHOD FOR SEARCHING IP ADDRESS OF ROUTING NODE IN VIRTUAL PRIVATE NETWORK ENVIRONMENT

(75) Inventor: Jung Hwan Lee, Seoul (KR)

(73) Assignee: INCA INTERNET CO., LTD., Seoul (KR)

(21) Appl. No.: 13/511,648

(22) PCT Filed: Nov. 18, 2010
(86) PCT No.: PCT/KR10/08151

§ 371 Date: May 23, 2012

(30) Foreign Application Priority Data
Nov. 23, 2009 (KR) 10-2009-0113214

(51) Int. Cl. G06F 15/173

(52) U.S. Cl. 709/224

(57) ABSTRACT

The present invention relates to a method for obtaining an IP address of a routing node nearest to a client computer in a virtual private network environment by modulating a routing table of the client computer. According to the present invention, a method for extracting IP address information of a routing node of an internal path of a virtual private network by an agent installed in a client computer comprises the steps of: the first step of, the agent, confirming whether the client computer is in a virtual private network environment by analyzing the routing table of the client computer; the second step of, the agent, obtaining a public IP of an information collection web server; the third step of, the agent, searching a path between a VPN server and the client computer passing through a physical gateway among paths of the routing table, generating an information collection path that has changed the destination of the searched path into the public IP of the information collection web server, and adding the generated path to the routing table; and the fourth step of, the agent, executing the information collection path, and obtaining a public IP address of the routing node from the executed result.

### TECHNICAL FIELD

The present invention relates, in general, to a method of searching for the Internet Protocol (IP) address of a routing node in a Virtual Private Network (VPN) environment, and, more particularly, to a method of acquiring the IP address of a routing node closest to a client computer in a VPN environment by manipulating the routing table of the client computer.

### BACKGROUND ART

FIG. 1 is a diagram illustrating a typical Internet access environment. In general, a client computer 11 accesses the Internet 14 via a gateway 12 and a routing node 13, and then accesses a web server 15. The web server 15 can generally determine the IP address of the client computer 11 from an access request packet of the client computer 11. Furthermore, when the web server 15 sends an Internet Control Message Protocol (ICMP) packet to the client computer 11, the client computer 11 responds to the ICMP packet. The web server 15 can collect the IP addresses of nodes that constitute a path over which the client computer 11 accesses the web server 15, from a response packet.

Since the number of public Internet IP addresses is generally limited, a plurality of client computers shares a limited number of public IPs. Separate private IP addresses are assigned to a plurality of client computers 11 that constitute the internal network of each routing node 13. For this reason, the routing node 13 is provided with a Network Address Translator (NAT), and translates the public IP addresses and the private IP addresses, assigned to the client computers 11, into each other. That is, in the case of an outbound packet from the client computer 11, a private IP address is translated into a public IP address and then the outbound packet is sent over the Internet 14. In the case of an inbound packet to the client computer 11, a public IP address is translated into a private IP address and then the inbound packet is sent to the client computer 11.

In a typical Internet access environment in which the client computer 11 uses a private IP address, as shown in FIG. 1, the web server 15 sends an ICMP packet to the client computer 11 and receives a response, thereby acquiring the public IP address of the routing node 13 and the private IP address of the client computer 11.

Meanwhile, a VPN is used that enables a public network, such as the Internet, to be used as if it had been constructed as a dedicated private network. This VPN does not divulge information about the internal network of the VPN for the purpose of protecting the terminals of the internal network of the VPN. This is referred to as the tunneling characteristic of a VPN.

FIG. 2 is a diagram illustrating an Internet access environment using a VPN. The client computer 11 accesses a VPN server 25 via an internal network gateway 22 and an internal network routing node 23. Then the VPN server 25 assigns a VPN IP address to the client computer 11, accesses the Internet 28 via an external gateway 26 and an external routing node 27, and then accesses a web server 29 that the client computer 21 intends to access. In this case, only a path from the VPN server 25 up to the web server 29 is disclosed to the outside of the VPN, and therefore it is impossible to acquire the IP address of the internal network gateway 22 or internal network routing node 23 that constitutes part of the internal network of the VPN of the client computer 11 in the outside of the VPN external.

Accordingly, although the actual client computer 21 gains access via the internal network gateway 22, the internal network routing node 23, the VPN server 25, the external gateway 26, and the external routing node 27, the internal network gateway 22 and the internal network routing node 23 are concealed by the tunneling characteristic, and therefore the information collection unit of the web server 29 or a separate information collection web server becomes aware that the client computer 21 is accessing the Internet 28 only via the VPN server 25, the external gateway 26 and the external routing node 27.

While the VPN implements security by applying tunneling to the internal network of the VPN to protect terminals that constitute the internal network of the VPN as described above, financial frauds abusing the tunneling characteristic of the VPN have recently become a social problem.

An example of financial fraud will now be described. The web server 29 that provides an Internet banking service to common client computers 21 determines whether to provide an on-line banking service by checking the geographical locations of the client computers 21. If an Internet banking transaction, such as an account transfer, in connection with a domestic subscriber account is attempted from a foreign country, this is blocked. However, if a Chinese fraud group determines an account number of a domestic bank and the password of a corresponding account, accesses a bank web server via a domestic VPN server using a Personal Computer (PC) in China and then attempts an Internet banking transaction, the bank web server mistakes a corresponding user as a domestic user based on the geographical location information of the domestic VPN server and then provides on-line banking service because the bank web server identifies only the domestic VPN server.

With regard to a client computer using a private IP address, in order to find out information about the geographical location of the corresponding client computer which is attempting to access a web server, the public IP address of a routing node which translates the private IP address of the corresponding client computer into a public IP address should be found out. As described above, a case where the client computer uses a VPN causes the problem of the web server being unable to search for information about a gateway and a routing node inside the VPN.

### DISCLOSURE

### Technical Problem

Accordingly, the present invention has been made keeping in mind the above problems occurring in the prior art, and an object of the present invention is to provide a method of searching for the IP address of a routing node, which is accessed by a client computer, by manipulating the routing table of the client computer that uses a private IP address in a VPN environment.

### Technical Solution

In order to accomplish the above object, the present invention provides a method of searching for an IP address of a routing node in a VPN environment, in which an agent installed in a client computer included in a VPN extracts information about the IP address of the routing node on a path inside the VPN, the method including:
a first step of, by the agent, determining whether the client computer is in the VPN environment by analyzing a routing table of the client computer;
a second step of, by the agent, acquiring a public IP address of an information collection web server;
a third step of, by the agent, searching a routing table for a path between the client computer and a VPN server passing through a physical gateway, creating an information collection path obtained by converting a destination of a found path into a public IP address of the information collection web server, and adding the information collection path to the routing table; and
a fourth step of, by the agent, executing the information collection path, and acquiring the public IP address of the routing node from results of such execution.

### Advantageous Effects

According to the above-described present invention, the advantage is achieved of being able to determine the public IP address of a routing node that translates the private IP address of a client computer and a public IP address into each other in a VPN environment, thereby accurately determining the geographical location of the client computer from the public IP address of the routing node.

### DESCRIPTION OF DRAWINGS

FIG. 1 is a diagram illustrating a typical Internet access environment;

FIG. 2 is a diagram illustrating an Internet access environment using a VPN; and

FIG. 3 is an operational flowchart illustrating a method of searching for the IP address of a routing node in a VPN environment according to an embodiment of the present invention.

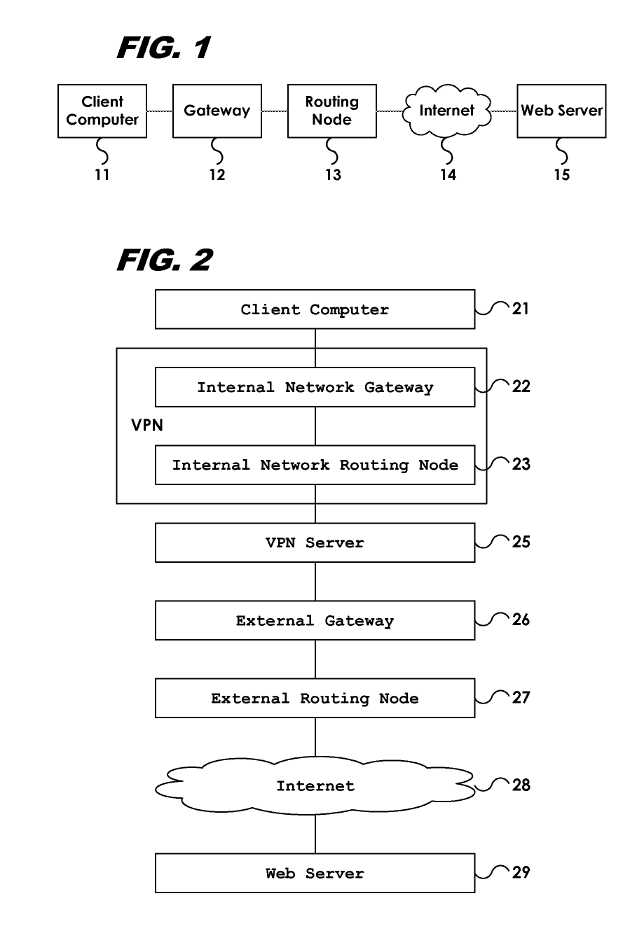

### BEST MODE

A method of searching for the IP address of a routing node in a VPN environment according to an embodiment of the present invention will be described in detail with reference to the accompanying drawings.

According to the present invention, a client computer accesses a web server via a VPN server using a VPN, as shown in FIG. 2, and an internal network routing node is provided with an NAT and translates the internal private IP address of the client computer (here, the internal private IP address is a private IP address that is assigned by the internal network routing node) and a public IP address into each other.

When a client computer 21 accesses a web server 29, as shown in FIG. 2, the information collection unit of the web server 29 or a separate information collection web server (hereinafter collectively referred to as an information collection web server) installs an agent that performs the functionality of searching for the IP address of the routing node in a VPN environment according to the present invention, in the client computer 21.

This agent is run when the client computer 21 accesses the web server 29, performs the function of searching for the IP address of the routing node in the VPN environment according to the present invention, and preferably sends information about the found IP address of the routing node to the information collection web server.

The information collection web server receives the IP address of the VPN internal routing node from the agent installed in the client computer 21, and stores it. Furthermore, the information collection web server can acquire information about the IP addresses of nodes constituting a path from the VPN server 25 to the web server 29 outside the VPN using a generally used method. Thereby, the information collection web server can acquire information about a principal path over which the client computer 21 accesses the web server 29, and information about the geographical location of the corresponding client computer 21.

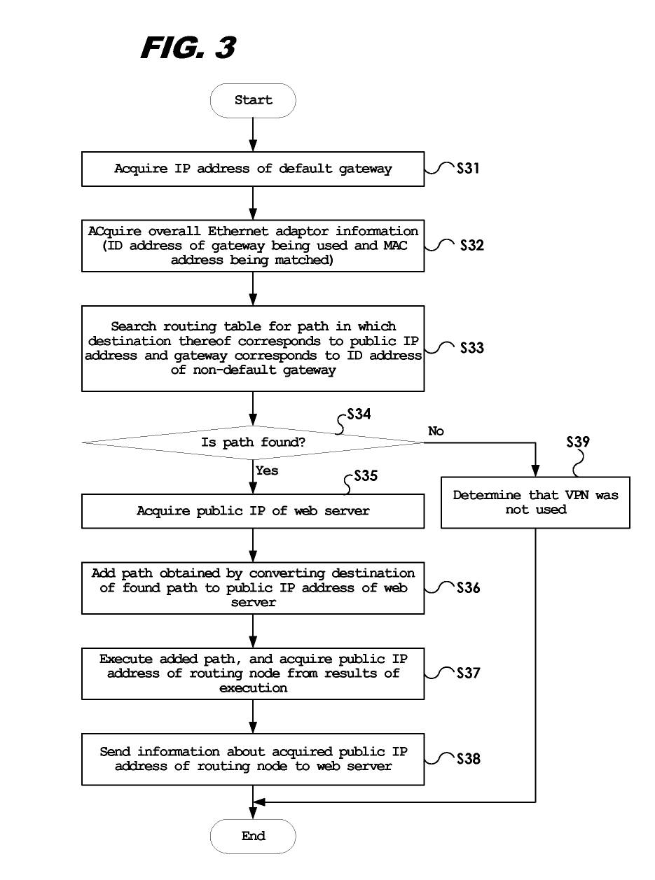

FIG. 3 is an operational flowchart illustrating the method of searching for the IP address of a routing node in a VPN environment according to the embodiment of the present invention.

First, when the agent is run, it determines whether a corresponding client computer is in a VPN environment.

The process of determining whether a corresponding client computer is in a VPN environment will now be described in detail. The agent acquires the IP address of a default gateway by analyzing the routing information of the routing table at step S31. The routing table is a database stored in the client computer, and is used to continuously store paths to specific destinations over a network (in some cases, distances related to paths). Table 1 shows an example of such a routing table.

TABLE 1

| Network | | | | Met- |
|---|---|---|---|---|
| Destination | Netmask | Gateway | Interface | ric |
| 0.0.0.0 | 128.0.0.0 | 11.1.0.1 | 11.1.0.35 | 1 |
| 0.0.0.0 | 0.0.0.0 | 192.168.2.1 | 192.168.2.68 | 20 |
| 11.1.0.0 | 255.255.252.0 | 11.1.0.35 | 11.1.0.35 | 30 |
| 11.1.0.0 | 255.255.252.0 | 11.1.0.1 | 11.1.0.35 | 1 |
| 11.1.0.35 | 255.255.255.255 | 127.0.0.1 | 127.0.0.1 | 30 |
| 11.255.255.255 | 255.255.255.255 | 11.1.0.35 | 11.1.0.35 | 30 |
| 61.255.239.232 | 255.255.255.255 | 192.168.2.1 | 192.168.2.68 | 1 |
| 127.0.0.0 | 255.0.0.0 | 127.0.0.1 | 127.0.0.1 | 1 |
| 128.0.0.0 | 128.0.0.0 | 11.1.0.1 | 11.1.0.35 | 1 |
| 192.168.2.0 | 255.255.255.0 | 192.168.2.68 | 192.168.2.68 | 20 |
| 192.168.2.68 | 255.255.255.255 | 127.0.0.1 | 127.0.0.1 | 20 |
| 192.168.2.255 | 255.255.255.255 | 192.168.2.68 | 192.168.2.68 | 20 |
| 224.0.0.0 | 240.0.0.0 | 11.1.0.35 | 11.1.0.35 | 30 |
| 224.0.0.0 | 240.0.0.0 | 192.168.2.68 | 192.168.2.68 | 20 |
| 255.255.255.255 | 255.255.255.255 | 11.1.0.35 | 11.1.0.35 | 1 |
| 255.255.255.255 | 255.255.255.255 | 192.168.2.68 | 192.168.2.68 | 1 |
| Default Gateway: | 11.1.0.1 | | | |

Referring to a routing table such as that of Table 1, a network destination, a netmask, a gateway, and an interface were stored for each path, and the IP address of the default gateway is given on the last line of the routing table. The agent acquires the IP address (11.1.0.1) of the default gateway by referring to the routing table at step S31.

Thereafter, the agent acquires Ethernet adapter information at step S32. When a command prompt is run on a Windows OS and then executes an “ipconfig/all” command, comprehensive Ethernet adapter information can be acquired. Table 2 shows the Ethernet adapter information of a client computer using a VPN. The IP address of the gateway that is being used by the client computer and a physical address (so-called Media Access Control (MAC) address) that matches the corresponding IP address of the gateway can be acquired at step S32. In the case of Table 2, two types of Ethernet adapter information, that is, Ethernet adapter information in the case where the client computer did not use a VPN and Ethernet adapter information in the case where the client computer used a VPN, are given.

TABLE 2
C:WDocuments and SettingsWzerosum>ipconfig/all

| | |
|---|---|
| Windows IP Configuration | |
| Host Name | work1 |
| Primary Dns Suffix | |
| Node Type | Unknown |
| IP Routing Enabled | No |
| WINS Proxy Enabled | No |
| DNS Suffix Search List | ns.kornet.net |
| Ethernet adapter local | |
| area connection: | |
| Connection-specific DNS Suffix | |
| Description | Broadcom NetLink (TM) |
| | Gigabit Ethernet |
| Physical Address | 00-1C-C4- - - |
| Dhcp Enabled | No |
| IP Address | 192. |
| Subnet Mask | 255.255.255.0 |
| Default Gateway | 192.168.2.1 |
| DNS Servers | 210.220.163.82 |
| Ethernet adapter local | |
| area connection 3: | |
| Connection-specific DNS Suffix | ns.kornet.net |
| Description | TAP-Win32 Adapter V9 |
| Physical Address | 00-FF-E5- - - |
| Dhcp Enabled | Yes |
| Autoconfiguration Enabled | Yes |
| IP Address | 11. |
| Subnet Mask | 255.255.252.0 |
| Default Gateway | 11.1.0.1 |
| DHCP Server | 11.1.0.0 |
| DNS Servers | 203.248.252.2 |
| Lease Obtained | October 23, 2009 Fri. 2:58:16 p.m. |
| Lease Expires | October 23, 2010 Sat. 2:58:16 p.m. |

From the example of Table 2, it can be seen that in the case of a first Ethernet adapter local area connection, the IP address of the default gateway is “192.168.2.1” and its matching MAC address Physical Address is “00-1C-C4 . . . ,” and in the case of a second Ethernet adapter local area connection 3, the IP address of the default gateway is “11.1.0.1” and its matching MAC address is “00-FF-E5 . . . ” The IP address of the default gateway of the second Ethernet adapter is identical to the IP address of the default gateway (11.1.0.1) that is acquired by referring to the routing table at step S31. Accordingly, the above-described default gateway of the first Ethernet adapter will be referred to as a non-default gateway IP address, and the default gateway of the second Ethernet adapter will be referred to as a default gateway IP address.

As a result, the agent acquires the IP address of the default gateway being used by the client computer and its matching MAC address, and the IP address of the non-default gateway and its matching MAC address at step 32.

Thereafter, the agent searches the routing table for a path in which a network destination corresponds to a public IP and a gateway corresponds to the IP address (192.168.2.1) of a non-default gateway path at step S33. Table 3 shows a path that satisfies the conditions of step S33 in the routing table of Table 1. Whether the destination corresponds to a public IP can be determined by determining whether the requirement of a common public IP address is satisfied. If the IP address ends with “0.0” or “255.255,” it is determined that the corresponding IP address is not a public IP.

TABLE 3

| Network | | | | Met- |
|---|---|---|---|---|
| Destination | Netmask | Gateway | Interface | ric |
| 0.0.0.0 | 128.0.0.0 | 11.1.0.1 | 11.1.0.35 | 1 |
| 0.0.0.0 | 0.0.0.0 | 192.168.2.1 | 192.168.2.68 | 20 |
| 11.1.0.0 | 255.255.252.0 | 11.1.0.35 | 11.1.0.35 | 30 |
| 11.1.0.0 | 255.255.252.0 | 11.1.0.1 | 11.1.0.35 | 1 |
| 11.1.0.35 | 255.255.255.255 | 127.0.0.1 | 127.0.0.1 | 30 |
| 11.255.255.255 | 255.255.255.255 | 11.1.0.35 | 11.1.0.35 | 30 |
| 61.255.239.232 | 255.255.255.255 | 192.168.2.1 | 192.168.2.68 | 1 |
| 127.0.0.0 | 255.0.0.0 | 127.0.0.1 | 127.0.0.1 | 1 |
| 128.0.0.0 | 128.0.0.0 | 11.1.0.1 | 11.1.0.35 | 1 |
| 192.168.2.0 | 255.255.255.0 | 192.168.2.68 | 192.168.2.68 | 20 |
| 192.168.2.68 | 255.255.255.255 | 127.0.0.1 | 127.0.0.1 | 20 |
| 192.168.2.255 | 255.255.255.255 | 192.168.2.68 | 192.168.2.68 | 20 |
| 224.0.0.0 | 240.0.0.0 | 11.1.0.35 | 11.1.0.35 | 30 |
| 224.0.0.0 | 240.0.0.0 | 192.168.2.68 | 192.168.2.68 | 20 |
| 255.255.255.255 | 255.255.255.255 | 11.1.0.35 | 11.1.0.35 | 1 |
| 255.255.255.255 | 255.255.255.255 | 192.168.2.68 | 192.168.2.68 | 1 |
| Default Gateway: | 11.1.0.1 | | | |

If, as a result of the searching at step S33, it is determined at step S34 that a path that satisfies the corresponding conditions is present, the agent determines that the client computer used a VPN. In the Ethernet adapter information of Table 2, the IP address of the non-default gateway is the real IP address of an actual physical gateway, and the IP address of the default gateway is the IP address of a virtual gateway that is assigned by the VPN server. In general, in the VPN environment, access is gained from the client computer to the VPN server using the real IP address of the real gateway. Step S33 is the step of searching for the path. Here, the found path is a path from the client computer to the VPN server. The destination of the path corresponds to the public IP address of the VPN server.

If it is determined that the client computer used the VPN, the agent acquires the public IP address of the information collection web server at step S35. Furthermore, an information collection path that is acquired by converting the destination of the path, found at step S33, into the public IP address of the information collection web server acquired at step S35 is added to the routing table at step S36.

Thereafter, the agent executes information collection path added at step S36, and acquires the public IP address of the routing node from the results of the execution at step S37. When this added information collection path is executed, the client computer accesses the information collection web server using the real IP of the physical gateway without intervention of the VPN server. Furthermore, the routing node including the NAT performs translation between the private IP and the public IP. Accordingly, the agent can determine the public IP address of the internal network of the VPN routing node by analyzing the information collection path.

The agent sends information about the acquired public IP address of the routing node to the information collection web server at step S38. Furthermore, the information collection path is deleted in the routing table.

Meanwhile, if there no path that is searched for at step S34, it is determined that the VPN was not used at step S39.

Meanwhile, the information collection web server can determine the geographical location of the corresponding routing node from the information about the public IP of the routing node, constituting part of the internal path of the VPN, sent by the agent of the client computer, and can estimate the geographical location of the corresponding client computer from the information about the geographical location of the routing node. Moreover, the information collection web server can determine whether to provide service to the client computer using the information about the geographical location of the client computer.

Meanwhile, the agent may send the IP address of the default gateway and its matching MAC address information, acquired at step S32, to the information collection web server. The information collection web server may determine whether the client computer operates as a virtual machine (VMware software or a virtual Personal Computer (PC)) using the IP address of the default gateway and its matching MAC address, and may utilize the results of the determination to calculate the extent of the risk of a financial accident.

Although the technical spirit of the present invention has been described in conjunction with the accompany drawings above, this is intended to illustrate the preferred embodiments of the present invention, but is not intended to limit the present invention. Furthermore, it will be apparent to those having ordinary knowledge in the field of the art that a variety of modifications and variations are possible within the range which does not depart from the scope of the technical spirit of the present invention.

1. A method of searching for an Internet Protocol (IP) address of a routing node in a Virtual Private Network (VPN) environment, in which an agent installed in a client computer included in a VPN extracts information about the IP address of the routing node on a path inside the VPN, the method comprising:
a first step of, by the agent, determining whether the client computer is in the VPN environment by analyzing a routing table of the client computer;
a second step of, by the agent, acquiring a public IP address of an information collection web server;
a third step of, by the agent, searching a routing table for a path between the client computer and a VPN server passing through a physical gateway, creating an information collection path obtained by converting a destination of a found path into a public IP address of the information collection web server, and adding the information collection path to the routing table; and
a fourth step of, by the agent, executing the information collection path, and acquiring the public IP address of the routing node from results of such execution.

2. The method of claim 1, wherein the first step comprises:
a first sub-step of, by the agent, acquiring an IP address of a current default gateway by analyzing the routing table;
a second sub-step of, by the agent, acquiring an IP address of a non-default gateway;
a third sub-step of, by the agent, searching the routing table for a path in which an address of a destination of the path is a public IP address and an address of a gateway is an IP address of a non-default gateway; and
a fourth sub-step of determining that the client computer is in the VPN environment if a path is found at the third sub-step.

3. The method of claim 2, wherein the third step comprises creating the information collection path by converting an address of a destination of the found path into the public IP address of the information collection web server.

4. The method of claim 1, further comprising, after the fourth step, by the agent, deleting the information collection path from the routing table.

5. The method of claim 1, further comprising, after the fourth step, by the agent, sending the information about the public IP address of the routing node to the information collection web server.

6. The method of claim 1, further comprising, by the agent, collecting information about a Media Access Control (MAC) address matched to an IP address of a default gateway, and sending the information about the MAC address to the information collection web server.
